(19) United States
(12) Patent Application Publication
(10) Pub. No.: US 2009/0004471 A1
(43) Pub. Date: Jan. 1, 2009

(54) Electrode Arrays and Methods of Fabrication Thereof

(76) Inventor: Franklin R. Amthor, Hoover, AL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/160,883

(22) PCT Filed: Jan. 17, 2007
(86) PCT No.: PCT/US07/01199

§ 371 Date: Jul. 14, 2008

Related U.S. Application Data
(60) Provisional application No. 60/759,379, filed on Jan. 17, 2006.

(51) Int. Cl. B32B 1/00; C08J 7/18

(52) U.S. Cl. 428/375; 427/553; 427/555

(57) ABSTRACT

Methods of forming a polymer layer and structures made from the method are disclosed.

### CROSS-REFERENCE TO RELATED APPLICATION

This application claims priority to U.S. provisional application entitled, “Electrode Arrays and Methods of Fabrication Thereof,” having Ser. No. 60/759,379, filed on Jan. 17, 2006, which is entirely incorporated herein by reference.

### STATEMENT REGARDING FEDERALLY SPONSORED RESEARCH OR DEVELOPMENT

This invention(s) was made with government support under Grant No.: NIH-NEI EY05070 awarded by the National Institutes of Health. The government has certain rights in the invention(s).

### BACKGROUND

There has been increasing interest in simultaneous recording of the spiking activity of multiple neurons in the last decade for numerous reasons. One reason is to advance big picture theories of how neurons work together to allow sensory perception, motor activity and other neural activities. Fundamental aspects of neural coding, such as synchronous firing, which are not discernable from single cell recordings, have been detected by simultaneous neural recordings. Other hypothesized sensory codes, such as order of firing, also require simultaneous, multi-unit recordings. Multi-electrode arrays for recording action potentials of neurons (spikes) are also equally adaptable as a way of stimulating sensory (e.g. retina), brain, or other neural tissue.

Multi-electrode arrays have universal application within the nervous system, and the retina has been a particularly prominent locus for the development of multi-unit recording arrays. Compared to brain slices where the cells are in a depressed state without most of their input, the retina can be removed without cutting the processes of any cells except the axons of the ganglion cells several millimeters from their somas. Since the input to the retina is light, which can be supplied and controlled just as well in the dish as in situ, the retina can be operated in vitro in a nearly normal state of responsiveness for many hours. A technical advantage for array recording is that in the retina all the spiking ganglion cells are located in a single, accessible layer close to the surface of the tissue.

There are two basic styles of multielectrode arrays developed for retina recording with respect to whether the ganglion cell layer to be recorded is on the bottom or top. One of the bottom recording types is that developed by Meister, Baylor and colleagues, and includes electrodes mounted on the bottom of a chamber in which the retina is placed, ganglion cell side down, and stimulated with light from above. Bottom-of-chamber configurations have also been reported by Grumet et al. (2000) and Heuschkel et al. (2002), and exist in commercial versions for brain slice recordings, with typical inter-electrode spacing and construction. The other style includes a penetrating array that is not transparent and has very large spacing of the wires (400 microns).

However, both styles suffer from one or more deficiencies and/or inadequacies. Accordingly, there is a need in the industry to address the deficiencies and/or inadequacies.

### SUMMARY

Methods of forming a polymer layer and structures made from the method are disclosed. In an embodiment, a method of forming a polymer layer, includes: providing a structure having a base substrate, wherein the base has a plurality of wires extending from the base to form an array of wires; exposing the base substrate and a first portion of the array of wires to a solution of a polymer; irradiating a portion of the solution adjacent at least one of the wires with an irradiating source, wherein the portion of the solution adjacent the wire surrounds the circumference of the wire along the length of the wire; forming a solid polymer layer around the irradiated portion of the wire to form an insulated wire having a solid polymer layer around the circumference of the wire along the length of wire exposed to the irradiation; and separating the polymer solution from the base substrate and the insulated wire.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views.

FIG. 1 illustrates an embodiment of an electrode array.

FIGS. 2A through 2D illustrate the fabrication process for the electrode array shown in FIG. 1.

FIGS. 3A through 3D illustrate the fabrication process for another embodiment of the electrode array.

### DETAILED DESCRIPTION

Electrode arrays and methods of forming electrode arrays are described herein. In general, the methods of forming the electrode arrays (e.g., a microelectrode array) include forming an insulating layer (e.g., a solid polymer layer) around the circumference of a portion of a wire of an array of wires, where the wires that comprise the array are disposed in a base substrate. In an embodiment, a portion of the tips of the wires at the end opposite the base substrate do not have the insulating layer on them, and therefore, the tip of each wire can be exposed to a substrate (e.g., a tissue). In another embodiment, a portion of the bottom of the wire near the base substrate does not have an insulating layer, and therefore, the wire is flexible at the base while also including the insulating layer.

In general, the electrode arrays can be used for processes such as, but not limited to, evaluating neural disorder, injuries, or degenerative conditions, recording and/or stimulating neurons, detecting chemical species or biological species, and combinations thereof. In an embodiment, the electrode arrays can be used in a prosthesis to perform one or more tasks (e.g., one set of electrodes can be used to monitor the signals from the brain, while another set of electrodes can be used to transmit those signals to other neurons, directly to the muscle, or the like). For example, the electrode array can be substantially transparent or optically transparent and used to measure and/or stimulate nerves in the eye. Additional details regarding the various features, configurations, and the like, of the electrode arrays and how the electrode arrays can be used are described in PCT/US04/18565 filed on Jun. 12, 2003 to Amthor, which is included herein by reference.

The electrode arrays and methods of the present disclosure are advantageous for at least the reason that other methods use known semiconductor techniques to form the electrode array, while the present disclosure does not use these techniques. The known techniques use optical masks to produce a two-dimensional insulating layer, which is problematic, time consuming, and expensive, since a three-dimensional insulating layer is formed around the wire. Other techniques that attempt to form the layer using a thin layer of polymer liquid encounter problems associated with oxygen inhibition, which causes the polymer liquid to not cure. The electrode arrays and methods of the present disclosure overcome at least these problems associated with other techniques.

The electrode arrays and methods of the present disclosure are inexpensive and less time consuming than other techniques. The electrode arrays and methods of the present disclosure can form an insulating layer around (e.g., around the circumference of the wire along a portion of the length of the wire) each of the wires in the array using one or more irradiation sources. In an embodiment, the insulating polymer layer is not continuous along the length of each wire, (e.g., includes 2 or more discontinuous portions). In another embodiment, every other wire (or some other fraction of wires) does not include the insulating polymer layer. Various configurations of the wire (e.g., some including the insulating polymer layer and others not) and various patterns of the insulating polymer layer on each wire (e.g., one or more wires having discontinuous insulating polymer layer portions along the length of the wire) can be used to allow the wires to be pushed through tissue to limit tissue damage.

The irradiation sources include, but are not limited to, laser irradiation sources, collimated light irradiation sources, high numerical aperture objective irradiation sources, low numerical aperture objective irradiation sources, light emitting diodes (LEDs) and combinations thereof. The irradiation source irradiates a volume of a polymer liquid that is disposed around the plurality of wires. The irradiation cures the polymer and forms a solid polymer layer (insulating layer) around the circumference of selected wires (performed sequentially or simultaneously) along a portion of the length of the wire. In an embodiment, the solid polymer layer is not formed on the tip of the wire (the recording tip).

In general, a base substrate having an array of wires is provided. Then, the base substrate and a portion of the array are exposed (e.g., submerged or partially submerged) to a polymer solution. In an embodiment, a portion of the wire at the end opposite the base substrate is not exposed to the polymer solution and/or the portion is treated and/or protected from the polymer solution. In an embodiment, a portion of the wire adjacent the base is not exposed to the polymer solution. The irradiation source is directed towards (e.g., substantially parallel with the wires and/or substantially perpendicular with the wires) one of the wires. In another embodiment, the irradiation source includes multiple irradiation sources so that multiple wires can be irradiated simultaneously. The polymer solution that is irradiated by the radiation energy from the irradiation source is cured or substantially cured to form a solid polymer layer around the portion of the wire exposed to the irradiation energy (e.g., a one or two photon process).

In general, the irradiation energy (e.g., from lasers, LEDs, or low numerical aperture objectives) forms a cylindrical and/or conical solid polymer layer around the circumference of the exposed portions of the wire. However, other cross-sections are contemplated such as, but not limited to, a polygonal cross section, a circular cross section, and an elliptical cross section. The shape of the substrate, a mask, and/or the container that includes the polymer solution can act as a shaping mold for the solid polymer layer to control the shape and/or dimensions of the solid polymer layer. In addition, it should be noted that the irradiation beam (e.g., energy), the irradiation beam volume, the beam geometry, combinations thereof, and the like can be used to shape the solid polymer layer. Furthermore, the three-dimensional positioning of the irradiation beam with respect to the substrate or wires in the polymer solution can be used to shape the solid polymer layer. In other words, the shape of the solid polymer layer (e.g., geometry around the wire and the dimensions) can be tailored using one or more of the variables described above and elsewhere in the application to form a solid polymer layer with a particular geometry and dimensions.

The laser irradiation sources and collimated light irradiation sources can include, but are not limited to, irradiation sources irradiating parallel light rays. Exemplary laser irradiation sources and collimated light irradiation sources include, but are not limited to, a blue laser, an ultraviolet laser, an infrared laser, light emitting diodes (e.g., blue or ultraviolet LEDs), fluorescent light sources, and combinations thereof. The sources can be operated at wavelengths appropriate for the polymer for one (e.g., about 410 nm to 360 nm) or two photon (e.g., 810 nm to 720 nm) processes. In an embodiment, a two photon source can be used to polymerize very small volumes because of the high nonlinear dependence on the beam intensity.

The high numerical aperture objective irradiation sources include, but are not limited to, a standard microscope (including a high numerical aperture objective) and an irradiation source (e.g., standard epi-fluorescence input (one photon) and confocal laser illumination (two photon)). The high numerical aperture objective can image within the polymer liquid. In particular, the high numerical aperture objective irradiation sources can be used to irradiate within an area of the polymer solution that is in the focus of the high numerical aperture objective. The high numerical aperture objective irradiation source allows a very small volume of the polymer liquid to be irradiated above the polymer-curing threshold. For example, a Nikon 40×, 60×, or 100× oil immersion objective can be used.

The irradiation source can include, but is not limited to, a laser (e.g., a blue laser, a ultraviolet laser, a infrared laser), or a standard epi-fluorescence source passing through an aperture (or mask) to restrict the x-y extent of the irradiation, where the irradiation source can be operated at the appropriate wavelength for one or two photon processes.

The higher the numerical aperture of the objective, the smaller the z-volume will be above threshold, as the cone of light becomes very flat. The highest numerical apertures are typically achieved with an oil immersion lens, for example. It should be noted that a scanning mode can be used to irradiate a volume to be cured (a volume around a wire). In an embodiment, when the high numerical aperture objective irradiation source uses a blue or an ultraviolet light irradiation source in conjunction with a high numerical aperture objective, sub-micron volumes (e.g., less than about 0.2 micrometers in the x- and y-axis, while less than about 0.4 micrometers in the z-axis) and tolerances can be achieved. It should be noted that the x- and y-axes here are defined as perpendicular to the wires, while the z-axis is parallel to the wires. In an embodiment, a number of the wires or all of the wires are substantially perpendicular or perpendicular to the base substrate (perpendicular to the x- and y-axes and parallel or substantially parallel the z-axis). It should be noted that one or more of the wires may not be perpendicular to the base substrate. Substantially perpendicular to the base substrate indicates that the wire is perpendicular to the base substrate with a deviation of about +/−20%, about +/−15%, about +/−10%, and about +/−5% from perpendicular to the base substrate.

The low numerical aperture objective irradiation sources include, but are not limited to, a low numerical aperture objective and an irradiation source. The array of wires would be oriented so that the wires are oriented along (parallel to) the irradiation path. The high numerical aperture objective can image within the polymer liquid. The low numerical aperture objective produces a gently tapered cone shaped irradiation volume. The “point” of the light cone is positioned a distance below the tip of the wire, and the base of the cone is positioned at the base substrate level, which is deeper in the polymer liquid. The irradiation source can include sources similar to those described in reference to high numerical aperture objective irradiation sources.

The base substrate can be made of materials such as, but not limited to, the same material as the insulating layer (as described below), one of the insulating layer materials but different than the insulating layer material used to cover the wires, a temporary support that can be removed (e.g., wax), a die where the wires emerge from holes in the die that could be used or removed prior to final use, or a permanent base that includes appropriate wiring for the intended use. In an embodiment, the base substrate is substantially transparent. In another embodiment, the base substrate is optically transparent (e.g., transparent to the eye of an animal or human). In yet another embodiment, the base substrate can have a combination of substantially transparent and optically transparent areas, which can be used as a mask for the irradiation to limit the irradiation to a portion of the array volume. The wires can be embedded within the base substrate. The wires can be interfaced with appropriate electronics within the base substrate, or the wires can pass through the base substrate and be interfaced with appropriate electronics to measure, stimulate, and/or record.

In an embodiment, the base substrate can include fiber optics. Fiber optic wires can be used in addition to or in place of one or more of the wires. The fiber optic wires could be used to irradiate the tissue, from which an electrical, conductive or neural response would be obtained from the tissue. The fiber optics could also receive light emitted by the tissue or light passing through the tissue, (e.g., light provided either by one or more of the fiber optics, or some other source).

In an embodiment, the base substrate can include reflecting surfaces (e.g., reflective metals or other reflective surfaces) to allow reflected radiation to assist in the polymerization of the polymer solution when the wire is opaque.

The dimensions of the wires (e.g., length, thickness, and height) depend, at least in part, upon the application, the wires, and the like. The dimensions can include appropriate dimensions for the particular applications as described herein.

The wire can include, but is not limited to, a microwire (e.g., having a diameter of about 4 to 500 micrometers), a bundle of nanowires (e.g., having a total diameter of about 4 to 500 micrometers), a microfiber (e.g., having a diameter of about 4 to 500 micrometers), a nanofiber (e.g., having a total diameter of about 4 to 500 micrometers and each fiber having the diameter of about 1 to 1000 μm), a microtube (e.g., having a total diameter of about 4 to 500 micrometers), a bundle of nanotube (e.g., having a total diameter of about 4 to 500 micrometers and each tube having a diameter of about 1 to 1000 μm), and combinations thereof.

The wire can be made of conductive materials or combinations of conductive materials. The wire can be made of conductive materials such as, but not limited to, carbon, metals (e.g., copper, gold, silver, nickel, titanium, platinum, iridium, stainless steel, and combinations thereof), and combinations thereof. In particular, the wire can include a carbon fiber, carbon nanotube(s), and wires made of organic conductors (e.g., organic polymers or conductive inks or pastes). Portions of the wire can be coated with materials such as, but not limited to, metals (e.g., copper, gold, silver, nickel, titanium, platinum, iridium, stainless steel, and combinations thereof), biologically compatible materials (e.g., PEG), and combinations thereof.

In an embodiment, the wire is composed of a plurality of nanowires, nanotubes, and/or nanofibers, where the individual components are bound together and/or encapsulated to achieve a final diameter of about 4-500 micrometers. One advantage of using a plurality of nanowires, nanotubes, and/or nanofibers is that this approach provides flexibility and a large surface area for recording and stimulation currents.

In an embodiment, the base substrate can include fluidic channels, or tubes can be used to introduce and/or remove chemicals and/or biological materials. In an embodiment, in place of one or more of the wires are a tube can be used in which a fluid can be flowed. In addition, channels can be introduced perpendicular to the wires and interconnected in various ways so that fluid can be injected into the vicinity of the wire tips (electrode tips), or withdrawn from this area to the substrate. For example, in an embodiment the tubes are parallel to the wire.

In an embodiment, the end of the wire can have a point formed electrolytically, for example. In another embodiment, the tips of the wires not covered by the solid polymer layer can have a metal or other chemical to detect by affinity conductivity changes (e.g., amperometrically detect) a chemical and/or biological species.

The wires can have various lengths, diameters, and/or spacing, which can depend, at least in part, on the particular application. For example, the spacing of the wires may depend on the tissue that the electrode array is being used to test. In one embodiment, the wires may be densely packed in one area while having a large spacing in another area because of the tissue being stimulated, measured, and/or recorded.

It should be noted that the length of the wire can be from about 0.01 millimeters (mm) to 10 mm, in increments of 0.01 mm. For example, the wires can have a length of about 0.01 mm to 10 mm, about 0.1 mm to 10 mm, and about 0.1 mm to 5 mm. It should be noted that the diameter of the wire can be from about 5 microns to 50 microns in increments of 0.01 microns. In an embodiment, the wires can have a diameter of about 4 microns to 15 microns. The length of the wire not having a solid polymer layer disposed thereon can be about 10 to 20 microns in increments of 0.01 microns. The dimensions of the wires can be uniform or may not be uniform, depending on the application.

The wires can have a wide range of spacing on the base substrate. In other words, the wires can be spaced apart by about two times the diameter of the wires to up to about 500 microns, in increments of the diameter of the wire. It should be noted that non-uniform spacing could be used in some embodiments. The spacing can also be a function of having only a portion of the wires with solid polymer layers so that the wires can be disposed closer together if appropriate.

The insulating layer (also referred to as “solid polymer layer”) can be formed from curing a polymer liquid at certain areas or volumes around the wires. In an embodiment, the insulating layer is substantially transparent, or in another embodiment, the insulating layer is optically transparent (e.g., transparent to an animal or a human). In an embodiment, the polymer liquid can include a material (e.g., a fluorescent material such as a fluorescent dye) that can be used to indicate the area being irradiated.

The polymer liquid can include polymers that are optically curable (e.g., by one or two photon processes) by one or more of the irradiation energies emitted by the irradiation sources described herein. The polymer can include, but is not limited to, ultraviolet light curable polymers, optical grade ultraviolet light curable polymers, infrared light curable polymers, optical grade light curable infrared polymers, two photon curable polymers, electron beam curable polymers, gamma radiation curable polymers, and combinations thereof. The ultraviolet light curable polymer can include, but is not limited to, a methacrylate, a methacrylate derivative, and combinations thereof.

The diameter of the insulating layer could be about 100 nanometers to a diameter where the insulating layer of each wire is contacting one another to form a continuous insulating layer. Typically, an area of no insulating layer exists between each insulating layer. The diameter of the insulating layer depends in part on the light diffraction in the system and the spacing of the wires. It should be noted that the length of the wire that the insulating layer covers could be from about 0.01 millimeters (mm) to about 10 mm, in increments of 0.01 mm.

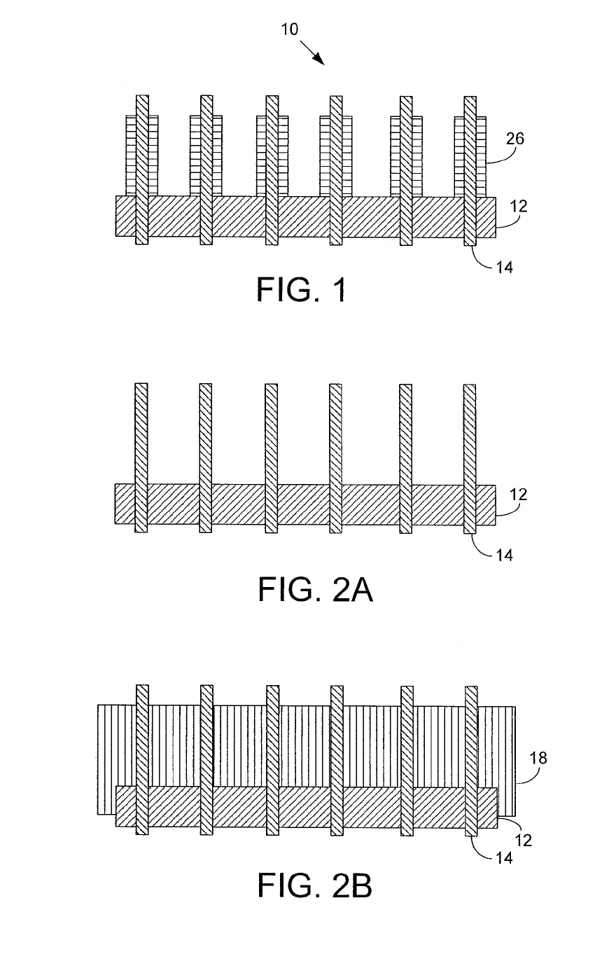

FIG. 1 illustrates an embodiment of an electrode array 10. The electrode array 10 includes, but is not limited to, a base substrate 12, a plurality of wires 14, and a plurality of solid polymer layers 26 disposed around each wire 14. The shape of the solid polymer layer 26 is cylindrical, while the cross-section can be different in other embodiments as described herein.

For the purposes of illustration only, and without limitation, embodiments of the present disclosure will be described with particular reference to the below-described fabrication methods. Note that not every step in the process is described with reference to the process illustrated in the figures hereinafter. Therefore, the following fabrication processes are not intended to be an exhaustive list that includes every step required to fabricate the embodiments of the illustrated components. In addition, the steps of the process can be performed in a different order to accomplish the same result.

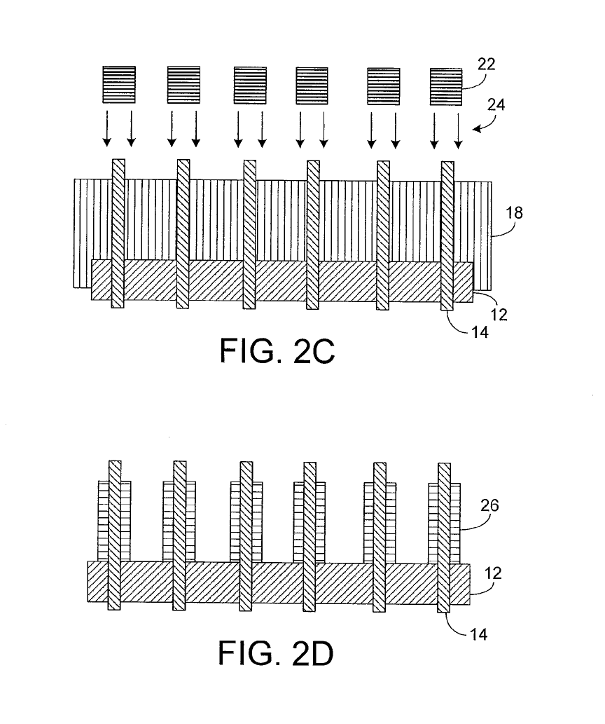

FIGS. 2A through 2D illustrate an embodiment of the fabrication process 20 for the electrode array shown in FIG. 1. FIG. 2A illustrates a base substrate 12 having wires 14 disposed through the base substrate 12. In another embodiment, the wires 14 terminate within the base substrate 12 and are interfaced with appropriate electronics. The base substrate 12 in FIG. 2A could also be a template containing holes into which the wires 14 are fed in a batch. In an embodiment, after the wires above the substrate are polymerized (or a portion of the wires are polymerized), the polymerized assembly is advanced upward in the illustration, the wires are cut above the substrate, as with a laser or high speed saw, and the process of polymerization repeated again, without limit.

FIG. 2B illustrates exposing the base substrate 12 and a portion of the wires 14 to a liquid polymer 18 (e.g., an ultraviolet curable polymer). A portion of the wires 14 is not exposed to the liquid polymer 18 as mentioned herein. This automatically prevents polymerization of the electrode tips, so that they remain exposed for recording or stimulating the tissue (e.g., eye tissue, muscle, and the like) or material to which they are contacted.

FIG. 2C illustrates an irradiation source 22 (e.g., a laser irradiation source) emitting radiation energy 24 (e.g., ultraviolet energy) at a certain volume around the wires 14. In another embodiment, the irradiation source 22 has a single radiation source and each wire is irradiated sequentially.

FIG. 2D illustrates the solid polymer layer 26 disposed around a portion of each of the wires 14 after the excess polymer liquid was removed. The dimensions of the solid polymer layer can be controlled by the irradiation energy, the polymer liquid, the exposure time, and the like. In an embodiment, a second, broad irradiation with the polymer lowered almost to the substrate 12 would allow a transparent base to be cast around the previous polymer near the substrate. This could also be done with an irradiation source perpendicular to the drawing restricted to this region.

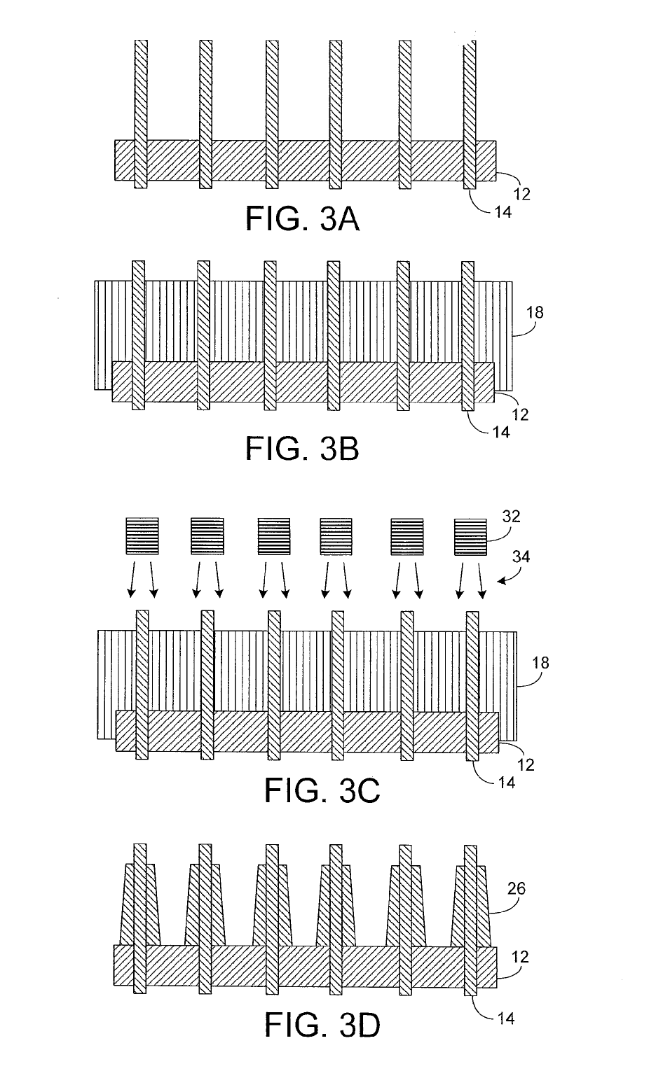

FIGS. 3A through 3D illustrate the fabrication process 20 for another embodiment of an electrode array shown in FIG. 1. FIG. 3A illustrates a base substrate 12 having wires 14 disposed through the base substrate 12. In another embodiment, the wires 14 terminate within the base substrate 12 and are interfaced with appropriate electronics.

FIG. 3B illustrates exposing the base substrate 12 and a portion of the wires 14 to a liquid polymer 18 (e.g., an ultraviolet curable polymer). A portion of the wires 14 is not exposed to the liquid polymer 18 as mentioned herein.

FIG. 3C illustrates an irradiation source 32 (e.g., a low numerical aperture objective irradiation source) emitting radiation energy 34 (e.g., ultraviolet energy) at a certain volume around the wires 14. In another embodiment, the irradiation source 32 has a single radiation source and each wire is irradiated sequentially.

FIG. 3D illustrates a conical solid polymer layer 36 disposed around a portion of each of the wires 14 after the excess polymer liquid was removed. The dimensions of the solid polymer layer can be controlled by the irradiation energy, the polymer liquid, the exposure time, and the like. The cones so formed can be made so that they are continuous or not at their bases, thus forming a polymer substrate, or not, at the bases. It should be noted that the high numerical aperture objective irradiation source can be used in ways similar to those described above. In addition, the high numerical aperture objective irradiation source can be positioned perpendicular to the wires and irradiate in a voxel-by-voxel manner to form the insulating layer.

In a particular embodiment, an embodiment of the present disclosure includes a wire array including 16 carbon fibers each having a diameter of 8 micrometers, equally spaced in 4 rows of 4 fibers with inter-fiber distances of 50 micrometers. The insulated lengths were 4 millimeters above the substrate with 50 micrometers at the tip uncoated with polymer. A length of several millimeters of carbon fiber protruded below the substrate, not insulated. Portions of several 1×4 25 micrometer diameter stainless steel substrates with the inter-wire distance being 100 micrometers have been cast, otherwise having the same dimensions above and below the substrate as the carbon fibers. The polymer used was Desotech Desobond 105. Two irradiation sources have been used: (1) a 405 nanometer LED (All Electronics), and a 405 nanometer laser (Edmund Scientific).

In another embodiment, arrays have been made in 4×4 configuration from 25 micron diameter stainless steel and/or tungsten wire, with the substrate flat and optically transparent, with only the tips approximately 50 microns emerging from the substrate. The emergence distance can be easily varied from 1 to 500 micrometers. The tip spacing has been done in both square and hexagonal arrays, with inter-electrode spacing of approximately 100 microns. Actual spacing can easily be any value from about 50 to 500 microns, and can be irregular (e.g., the spacing is not uniform in that a spacing from one tip to the next is 50 microns, while the spacing between two other tips is 500 microns). The tip extension distances can also be different from tip to tip. In embodiments, for at least some of the wires, the portion of the wires at the opposite surface of the substrate from the tips are bent at right angles where they emerge from the substrate so they are parallel to the substrate where they make electrical connections outside the region of the tips to electrical circuitry via being bonded to pads, by soldering or conductive paste or glue, or where they are mechanically bonded to terminals for electrical connection to electrical circuitry such as amplifiers and current injectors.

One use, among many, of this configuration would be for placing tissue, such as an isolated retina or “brain slice” on top of the array where the tips protruded for recording and/or stimulating neurons.

In another embodiment, the substrate might not be irradiated in some places between the insulated wires to form a continuous hole through the substrate. This hole would allow the introduction or removal of fluid samples, to or from the tissue above.

In another embodiment, a second irradiation stage could be used to form a number of pedestals that could be created running along the wire tips so that there were square channels running along and between the protruding tips. Fluid could be introduced into these channels for metabolic maintenance of the tissue, and for the introduction of test substances in small volumes, and for the withdrawal of small samples of fluid for testing outside the array.

It should be emphasized that the above-described embodiments of the present disclosure are merely possible examples of implementations, and are merely set forth for a clear understanding of the principles of the disclosure. Therefore, many variations and modifications may be made to the above-described embodiment(s) of the disclosure without departing substantially from the spirit and principles disclosed herein. All such modifications and variations are intended to be included herein within the scope of this disclosure.

Therefore, the following is claimed:

1. A method of forming a polymer layer, comprising:
providing a structure having a base substrate, wherein the base has a plurality of wires extending from the base to form an array of wires;
exposing the base substrate and a first portion of the array of wires to a solution of a polymer;
irradiating a portion of the solution adjacent at least one of the wires with an irradiating source, wherein the portion of the solution adjacent the wire surrounds the circumference of the wire along the length of the wire,
forming a solid polymer layer around the irradiated portion of the wire to form an insulated wire having a solid polymer layer around the circumference of the wire along the length of wire exposed to the irradiation;
separating the polymer solution from the base substrate and the insulated wire.

2. The method of claim 1, wherein the irradiating source is selected from a laser irradiation source, a high numerical aperture objection irradiation source, a low numerical aperture objection irradiation source, and a collimated light irradiation source.

3. The method of claim 1, wherein the wire is selected from: a carbon wire, a nanowire, a metal wire, and a nanotube.

4. The method of claim 1, wherein the polymer is selected from: ultraviolet light curable polymers, infrared light curable polymers, and combinations thereof.

5. The method of claim 1, wherein the wire has a diameter of about 5 microns to 50 microns.

6. The method of claim 1, wherein the solid polymer layer has a diameter of about 5 microns to 50 microns.

7. The method of claim 1, wherein the solid polymer layer has a length of about 0.01 mm to 10 mm.

8. The method of claim 1, further comprising: controlling the shape of the solid polymer layer using the base substrate.

9. The method of claim 1, further comprising: controlling the shape of the solid polymer layer using the irradiating source.

10. The method of claim 1, wherein a second portion of the array of wires at the end opposite the base is not exposed to the solution.

11. The method of claim 10, wherein the second portion of the wire has a length of about 0.01 mm to 10 mm.

12. The method of claim 1, wherein a portion of the wires of the array of wires are substantially parallel to the base substrate.

13. The method of claim 1, wherein a portion of the wires of the array of wires are not substantially parallel to the base substrate.

14. A structure, comprising a structure formed using the method of claim 1.

15. The structure of claim 14, wherein the formation is controlled by the base substrate.
